(19) United States
(12) Patent Application Publication
(10) Pub. No.: US 2021/0082181 A1
(43) Pub. Date: Mar. 18, 2021

(54) METHOD AND APPARATUS FOR OBJECT DETECTION, INTELLIGENT DRIVING METHOD AND DEVICE, AND STORAGE MEDIUM

(71) Applicant: SENSETIME GROUP LIMITED, HONG KONG (CN)

(72) Inventors: Shaoshuai SHI, Hong Kong (CN); Zhe Wang, Hong Kong (CN); Xiaogang Wang, Hong Kong (CN); Hongsheng Li, Hong Kong (CN)

(21) Appl. No.: 17/106,826

(22) Filed: Nov. 30, 2020

Related U.S. Application Data
(63) Continuation of application No. PCT/CN2019/121774, filed on Nov. 28, 2019.

(30) Foreign Application Priority Data
Jun. 17, 2019 (CN) 201910523342.4

(51) Int. Cl. G06T 17/00

(52) U.S. Cl. CPC G06T 17/00; G06T 2210/12

(57) ABSTRACT

Disclosed are a method and apparatus for object detection, an electronic device and a computer storage medium. The method includes: acquiring three-dimensional (3D) point cloud data; determining point cloud semantic features corresponding to the 3D point cloud data according to the 3D point cloud data; determining part location information of foreground points based on the point cloud semantic features; extracting at least one initial 3D bounding box based on the point cloud data; and determining a 3D bounding box for an object according to the point cloud semantic features corresponding to the point cloud data, the part location information of the foreground points and the at least one initial 3D bounding box.

### CROSS-REFERENCE TO RELATED APPLICATION

This application is a continuation of International Application No. PCT/CN2019/121774, filed on Nov. 28, 2019, which claims priority to Chinese Patent Application No. 201910523342.4, filed to the National Intellectual Property Administration, PRC on Jun. 17, 2019 and entitled “Method and apparatus for object detection, Intelligent Driving Method and Device, and Storage Medium”. The contents of International Application No. PCT/CN2019/121774 and Chinese Patent Application No. 201910523342.4 are hereby incorporated by reference in their entireties

### TECHNICAL FIELD

The disclosure relates to an object detection technology, and particularly to a method for object detection, an intelligent driving method, an apparatus for object detection, an electronic device and a computer storage medium.

### BACKGROUND

In the field of autonomous driving, robots, etc., a core problem is how to sense an object around. In a related art, acquired point cloud data may be projected to a top view, and a box in the top view is obtained by use of a two-dimensional (2D) detection technology. In such a manner, original information of a point cloud is lost during quantification, and it is difficult to detect an occluded object during detection from a 2D image.

### SUMMARY

Embodiments of the disclosure are intended to provide technical solutions for object detection.

The embodiments of the disclosure provide a method for object detection, including: acquiring three-dimensional (3D) point cloud data; determining point cloud semantic features corresponding to the 3D point cloud data according to the 3D point cloud data; determining part location information of foreground points based on the point cloud semantic features, wherein the foreground points represent point cloud data belonging to an object in the 3D point cloud data, and the part location information of the foreground points indicates a relative location of each of the foreground points in the object; extracting at least one initial 3D bounding box based on the 3D point cloud data; and determining a 3D bounding box for the object according to the point cloud semantic features corresponding to the 3D point cloud data, the part location information of the foreground points, and the at least one initial 3D bounding box, wherein the object exists in a region in the 3D bounding box.

The embodiments of the disclosure also provide an intelligent driving method, applied to an intelligent driving device and including: obtaining a three-dimensional (3D) bounding box for an object around the intelligent driving device according to any above method for object detection; and generating a driving policy according to the 3D bounding box for the object.

The embodiments of the disclosure provide an apparatus for object detection, including a processor; and a memory configured to store instructions which when being executed by the processor, cause the processor to carry out the following: acquiring three-dimensional (3D) point cloud data; determining point cloud semantic features corresponding to the 3D point cloud data according to the 3D point cloud data; determining part location information of foreground points based on the point cloud semantic features, wherein the foreground points represent point cloud data belonging to an object in the 3D point cloud data, and the part location information of the foreground points indicates a relative location of each of the foreground points in the object; extracting at least one initial 3D bounding box based on the 3D point cloud data; and determining a 3D bounding box for the object according to the point cloud semantic features corresponding to the 3D point cloud data, the part location information of the foreground points, and the at least one initial 3D bounding box, wherein the object exists in a region in the 3D bounding box.

The embodiments of the disclosure provide an apparatus for object detection, including an acquisition module, a first processing module and a second processing module.

The acquisition module is configured to acquire three-dimensional (3D) point cloud data and determine point cloud semantic features corresponding to the 3D point cloud data according to the 3D point cloud data. The first processing module is configured to determine part location information of foreground points based on the point cloud semantic features, wherein the foreground points represent point cloud data belonging to an object in the 3D point cloud data, and the part location information of the foreground points indicates a relative location of each of the foreground points in the object, and extract at least one initial 3D bounding box based on the 3D point cloud data. The second processing module is configured to determine a 3D bounding box for the object according to the point cloud semantic features corresponding to the 3D point cloud data, the part location information of the foreground points, and the at least one initial 3D bounding box, wherein the object exists in a region in the 3D bounding box.

The embodiments of the disclosure also disclose an electronic device, including a processor and a memory configured to store a computer program capable of running in the processor, wherein the processor is configured to run the computer program to execute any above method for object detection.

The embodiments of the disclosure also disclose a non-transitory computer storage medium having stored thereon a computer program that, when being executed by a computer, causes the computer to carry out the following: acquiring three-dimensional (3D) point cloud data; determining point cloud semantic features corresponding to the 3D point cloud data according to the 3D point cloud data; determining part location information of foreground points based on the point cloud semantic features, wherein the foreground points represent point cloud data belonging to an object in the 3D point cloud data, and the part location information of the foreground points indicates a relative location of each of the foreground points in the object; extracting at least one initial 3D bounding box based on the 3D point cloud data; and determining a 3D bounding box for the object according to the point cloud semantic features corresponding to the 3D point cloud data, the part location information of the foreground points, and the at least one initial 3D bounding box, wherein the object exists in a region in the 3D bounding box.

The embodiments of the disclosure also provide a computer program product, including computer-executable instructions that, when being executed, implement any method for object detection provided in the embodiments of the disclosure.

It is to be understood that the above general description and the following detailed description are only exemplary and explanatory and not intended to limit the disclosure.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 illustrates a flowchart of a method for object detection according to embodiments of the disclosure.

FIG. 2 illustrates a schematic diagram of a comprehensive framework of a 3D part-aware and aggregation neural network according to an application embodiment of the disclosure.

FIG. 3 illustrates a block diagram of a module for sparse upsampling and feature correction according to an application embodiment of the disclosure.

FIG. 4 illustrates a detailed error statistical diagram of intra-object part locations obtained for a VAL segmentation set of a KITTI dataset at different difficulty levels according to an application embodiment of the disclosure.

FIG. 5 illustrates a schematic diagram of a compositional structure of an apparatus for object detection according to embodiments of the disclosure.

FIG. 6 illustrates a schematic diagram of a hardware structure of an electronic device according to embodiments of the disclosure.

### DETAILED DESCRIPTION

The disclosure will further be described below in combination with the drawings and the embodiments in detail. It is to be understood that the embodiments provided herein only serve to explain the disclosure and are not intended to limit the disclosure. In addition, the embodiments provided below are not all embodiments implementing the disclosure but part of embodiments implementing the disclosure, and the technical solutions disclosed in the embodiments of the disclosure may be freely combined for implementation without conflicts.

It is to be noted that, in the embodiments of the disclosure, terms “include” and “contain” or any other variant thereof is intended be non-exclusive herein, so that a method or device including a series of elements not only includes those clearly recorded elements but also includes other elements which are not clearly listed or further includes intrinsic elements for implementing the method or the device. Without more limitation, an element defined by a statement “including a/an” does not exclude existence of other related elements (for example, actions in the method or units in the device, the unit may be, for example, part of a circuit, part of a processor, part of a program or software, or the like) in a method or device including the element.

For example, a method for object detection or an intelligent driving method provided in the embodiments of the disclosure includes a series of actions, but the method for object detection or the intelligent driving method provided in the embodiments of the disclosure is not limited to the disclosed actions. Similarly, an apparatus for object detection provided in the embodiments of the disclosure includes a series of modules, but the apparatus provided in the embodiments of the disclosure is not limited to including the clearly disclosed modules and may further include a module needing to be set when related information is acquired or processing is performed based on information.

In the disclosure, the term “and/or” only describes an association relationship between associated objects and represents that three relationships may exist. For example, A and/or B may represent three situations: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

The embodiments of the disclosure may be applied to a computer system that consists of a terminal and a server and may operate together with numerous other universal or dedicated computing system environments or configurations. Herein, the terminal may be a thin client, a thick client, a handheld or laptop device, a microprocessor-based system, a set-top box, a programmable consumer electronic product, a network personal computer, a small computer system or the like. The server may be a server computer system, a small computer system, a large computer system, a distributed cloud computing technical environment including any abovementioned system, and the like.

An electronic device such as the terminal and the server may be described in a general context of computer system executable instructions (for example, a program module) executed by the computer system. Generally, the program module may include a routine, a program, a target program, a component, a logic, a data structure or the like, which execute specific tasks or implement specific abstract data types. The computer system/server may be implemented in a distributed cloud computing environment, and in the distributed cloud computing environment, tasks are executed by a remote processing device connected through a communication network. In the distributed cloud computing environment, the program module may be located in a storage medium of a local or remote computer system including a storage device.

In the related art, along with rapid development of autonomous driving and robot technologies, a point cloud data-based 3D object detection technology has attracted more and more attentions of people. Point cloud data may be acquired based on a radar sensor. Although significant achievements have been made in 2D object detection from images, it is still difficult to apply a method for 2D object detection to point cloud-based 3D object detection. This is mainly because point cloud data generated based on a laser radar (LiDAR) sensor is sparse and irregular and how to extract and recognize point cloud semantic features from irregular points and segment a foreground from a background according to the extracted features to determine a 3D bounding box is still a challenging issue.

In the fields of autonomous driving, robots and the like, 3D object detection is an important research direction. For example, important information such as specific locations, shapes and sizes, movement directions and the like of vehicles and pedestrians around may be determined by 3D object detection, thereby helping an autonomous driving vehicle or a robot to make action decisions.

At present, in a relevant 3D object detection solution, a point cloud is usually projected to a top view, and a box in the top view is obtained by use of a 2D detection technology, or a candidate box is selected directly by use of a 2D image; and then a corresponding 3D bounding box is obtained by regression in a specific region of the point cloud. Herein, the box in the top view obtained by use of the 2D detection technology is a 2D box, and the 2D box represents a 2D planar box configured to identify point cloud data of an object. The 2D box may be a rectangular box or a box in another 2D planar shape.

It can be seen that, original information of the point cloud is lost during quantification in the case of projecting the point cloud to the top view and it is difficult to detect an occluded object when the detection is performed in the 2D image. In addition, when the abovementioned solution is used in 3D detection, part information of the object is not independently considered. For example, for an automobile, location information of a part such as the head, the tail and a wheel helps 3D detection of an object.

For the foregoing technical problem, a method for object detection is provided in some embodiments of the disclosure. The embodiments of the disclosure may be implemented in a scenario of autonomous driving, robot navigation or the like.

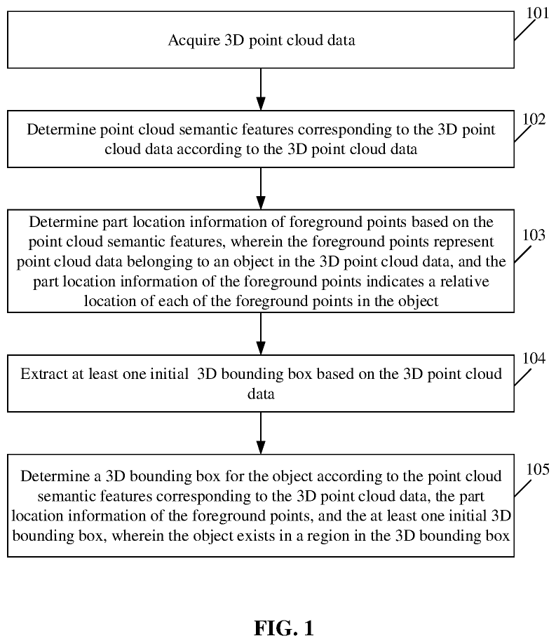

FIG. 1 illustrates a flowchart of a method for object detection according to embodiments of the disclosure. As illustrated in FIG. 1, the flow may include the following actions.

In 101, 3D point cloud data is acquired.

During practical application, the point cloud data may be acquired based on a radar sensor or the like.

In 102, point cloud semantic features corresponding to the 3D point cloud data are determined according to the 3D point cloud data.

For the point cloud data, in order to segment a foreground from a background and predict 3D intra-object part location information of foreground points, it is necessary to learn distinctive point-wise features from the point cloud data. For an implementation of obtaining the point cloud semantic features corresponding to the point cloud data, exemplarily, 3D meshing may be performed on the whole point cloud to obtain 3D meshes, and the point cloud semantic features corresponding to the 3D point cloud are extracted from non-null meshes among the 3D meshes. The point cloud semantic features corresponding to the 3D point cloud data may indicate coordinate information and the like of the 3D point cloud data.

During practical implementation, a center of each mesh may be taken as a new point, thus obtaining a meshed point cloud approximately equivalent to the initial point cloud. The meshed point cloud is usually sparse. After the meshed point cloud is obtained, point-wise features of the meshed point cloud may be extracted based on a sparse convolution operation. Herein, the point-wise features of the meshed point cloud include a semantic feature of each point in the meshed point cloud, and may be determined as the point cloud semantic features corresponding to the above point cloud data. That is, the meshing may be performed by taking a whole 3D space as standardized meshes, and then the point cloud semantic features are extracted from the non-null meshes based on sparse convolution.

In 3D object detection, for the point cloud data, the foreground and the background may be segmented from each other, to obtain the foreground points and background points. The foreground points represent point cloud data belonging to an object, and the background points represent point cloud data belonging to no object. The object may be an object needing to be recognized, such as a vehicle or a human body. For example, a method for segmenting the foreground from the background includes, but not limited to, a threshold-based segmentation method, a region-based segmentation method, an edge-based segmentation method and a specific-theory-based segmentation method.

A non-null mesh among the 3D meshes is a mesh containing point cloud data, and a null mesh among the 3D meshes is a mesh containing no point cloud data.

For an implementation of performing 3D sparse meshing on the whole point cloud data, in a particular example, the whole 3D space has a size of 70 m*80 m*4 m, and each mesh has a size of 5 cm*5 cm*10 cm. For each 3D scenario in a KITTI dataset, there are usually 16,000 non-null meshes.

In 103, part location information of foreground points is determined based on the point cloud semantic features. The foreground points represent point cloud data belonging to an object in the 3D point cloud data, and the part location information of the foreground points indicates a relative location of each of the foreground points in the object.

For an implementation of predicting the part location information of the foreground points, exemplarily, the foreground and the background in the point cloud data may be segmented from each other according to the point cloud semantic features, to determine the foreground points. The foreground points are the point cloud data belonging to the object in the point cloud data.

The determined foreground points are processed by a neural network to obtain the part location information of the foreground points. The neural network is configured to predict the part location information of the foreground points.

The neural network is trained by using a training dataset including annotation information of a 3D box. The annotation information of the 3D box at least includes part location information of foreground points in point cloud data in the training dataset.

In the embodiments of the disclosure, the method for segmenting the foreground from the background is not limited. For example, a focal loss method or the like may be used in segmenting the foreground from the background.

During practical application, the training dataset may be acquired in advance. For example, for a scenario requiring object detection, point cloud data may be acquired in advance by a radar sensor or the like. Then foreground point segmentation is performed for the point cloud data, and a 3D box is divided. The annotation information is added to the 3D box to obtain the training dataset. The annotation information may represent part location information of the foreground points in the 3D box. Herein, the 3D box in the training dataset may be denoted as a ground-truth box.

Herein, the 3D box represents a stereo box configured to identify the point cloud data of the object, and the 3D box may be a cuboid or a stereo box in another shape.

Exemplarily, after the training dataset is obtained, the part location information of the foreground points may be predicted based on the annotation information of the 3D box in the training dataset by taking a binary cross entropy loss as a part regression loss. Optionally, the training is performed with all points in or outside the ground-truth box being taken as positive and negative samples.

During practical application, the annotation information of the 3D box includes accurate part location information, has the characteristic of containing rich information and may be obtained for free. That is, according to the technical solution of the embodiments of the disclosure, the intra-object part location information of the foreground points may be predicted based on free supervision information deduced from the annotation information of the 3D box.

It can be seen that, in the embodiments of the disclosure, information of the original point cloud data may be directly extracted based on the sparse convolution operation, and may be configured to segment the foreground from the background and predict part location information of each foreground point (i.e., location information in the 3D bounding box for the object). Thus, information about which part in the object that each point belongs to may be represented in a quantified manner. In such a manner, the problem of loss occurred in quantification when a point cloud is projected to a top view and the problem of occlusion existing during 2D image detection in the related art are solved, and the process of extracting the point cloud semantic features may be more natural and efficient.

In 104, at least one initial 3D bounding box is extracted based on the 3D point cloud data.

For an implementation of extracting the at least one initial 3D bounding box based on the 3D point cloud data, exemplarily, at least one candidate 3D bounding box may be extracted by use of a Region Proposal Network (RPN), each candidate 3D bounding box being an initial 3D bounding box. It is to be noted that the above is only exemplary description about a manner of extracting the initial 3D bounding box, and the embodiments of the disclosure are not limited thereto.

In the embodiments of the disclosure, the part location information of all points in the initial 3D bounding box may be aggregated, to facilitate generating a final 3D bounding box. That is, the predicted part location information of each foreground point may be helpful for generating the final 3D bounding box.

In 105, a 3D bounding box for the object is determined according to the point cloud semantic features corresponding to the 3D point cloud data, the part location information of the foreground points, and the at least one initial 3D bounding box. The object exists in a region in the 3D bounding box.

For an implementation of this action, exemplarily, for each of the at least one initial 3D bounding box, a pooling operation may be executed on respective part location information of foreground points and respective point cloud semantic features, to obtain respective pooled part location information and respective pooled point cloud semantic features; and at least one of the following is performed so as to determine the 3D bounding box for the object: each of the at least one initial 3D bounding box is corrected according to the respective pooled part location information and the respective pooled point cloud semantic features, or a respective confidence of each of the at least one initial 3D bounding box is determined according to the respective pooled part location information and the respective pooled point cloud semantic features.

Herein, after each initial 3D bounding box is corrected, the final 3D bounding box may be obtained, so as to implement object detection. The confidence of the initial 3D bounding box may be configured to represent a confidence of the part location information of the foreground point in the initial 3D bounding box. Thus, determining the confidence of the initial 3D bounding box is favorable for correcting the initial 3D bounding box to obtain the final 3D bounding box.

Herein, the 3D bounding box for the object may represent a 3D bounding box for object detection. Exemplarily, after the 3D bounding box for the object is determined, information of the object in an image may be determined according to the 3D bounding box for the object. For example, information of a location, size and the like of the object in the image may be determined according to the 3D bounding box for the object.

In the embodiments of the disclosure, for the part location information of the foreground points corresponding to each initial 3D bounding box and the point cloud semantic features corresponding to each initial 3D bounding box, part location information of all points in the same initial 3D bounding box needs to be aggregated to score the confidence of the 3D bounding box and/or correct the 3D bounding box.

In a first example, features of all the points in the initial 3D bounding box may be directly acquired and aggregated to score the confidence of the 3D bounding box and correct the 3D bounding box. That is, the part location information and point cloud semantic features corresponding to the initial 3D bounding box may also be pooled directly to further implement confidence scoring and/or correction of the initial 3D bounding box. Due to the sparsity of the point cloud, the method in the first example cannot recover a shape of the initial 3D bounding box from the pooled features, and the information of the initial 3D bounding box is lost.

In a second example, each initial 3D bounding box may be uniformly divided into multiple meshes, and for each of the multiple meshes, the pooling operation is executed on respective part location information of the foreground points and a respective point cloud semantic feature, to obtain, for each initial 3D bounding box, the respective pooled part location information and the respective pooled point cloud semantic features.

It can be seen that, for initial 3D bounding boxes at different sizes, meshed 3D features of a fixed resolution may be generated. Optionally, uniform meshing may be performed on each initial 3D bounding box in the 3D space according to a set resolution, the set resolution being denoted as a pooling resolution.

Optionally, in response to that there is no foreground point in one of the multiple meshes, this mesh is a null mesh. In such case, part location information of this mesh may be labeled to be null, and a point cloud semantic feature of the mesh may be set to be 0 to obtain a pooled point cloud semantic feature of the mesh.

In response to that there is at least one foreground point in one of the multiple meshes, uniform pooling may be performed on part location information of the foreground points in the mesh to obtain pooled part location information of the foreground points in the mesh, and max-pooling is performed on a point cloud semantic feature of the foreground points in the mesh to obtain a pooled point cloud semantic feature of the mesh. Herein, uniform pooling may refer to taking an average value of part location information of foreground points in neighborhoods as pooled part location information of the foreground point in the mesh. Max-pooling may refer to taking a maximum value of the point cloud semantic features of the foreground points in the neighborhoods as the pooled point cloud semantic feature of the foreground point in the mesh.

It can be seen that, after uniform pooling is performed on the part location information of the foreground points, the pooled part location information may approximately indicate center location information of each mesh.

In the embodiments of the disclosure, after the pooled part location information of the foreground point in the mesh and the pooled point cloud semantic feature of the mesh are obtained, for the pooled part location information and the respective pooled point cloud semantic features may be obtained for each initial 3D bounding box. Herein, the pooled part location information corresponding to each initial 3D bounding box includes pooled part location information of the foreground point in each mesh corresponding to the initial 3D bounding box, and the pooled point cloud semantic features corresponding to each initial 3D bounding box include the pooled point cloud semantic feature of each mesh corresponding to the initial 3D bounding box.

When the pooling operation is executed on the part location information of the foreground point and the point cloud semantic feature that correspond to each mesh, corresponding processing is also performed on a null mesh. Therefore, geometric information of the 3D initial box may be encoded better through the pooled part location information corresponding to each initial 3D bounding box and the pooled point cloud semantic features corresponding to each initial 3D bounding box. Hence, it may be considered that a pooling operation sensitive to the initial 3D bounding box is proposed in the embodiments of the disclosure.

Through the pooling operation sensitive to the initial 3D bounding box in the embodiments of the disclosure, pooled features of the same resolution may be obtained from the initial 3D bounding boxes at different sizes, and the shapes of the 3D initial boxes may be recovered from the pooled features. In addition, the pooled features may be favorable for integrating the part location information in the initial 3D bounding boxes, and thus being favorable for scoring the confidences of the initial 3D bounding boxes and correcting the initial 3D bounding boxes.

For an implementation of performing at least one of the following: correcting each of the at least one initial 3D bounding box according to the respective pooled part location information and the respective pooled point cloud semantic features, or determining the respective confidence of each of the at least one initial 3D bounding box according to the respective pooled part location information and the respective pooled point cloud semantic features, exemplarily, for each of the at least one initial 3D bounding box, the respective pooled part location information and the respective pooled point cloud semantic features may be merged, and each of the at least one initial 3D bounding box is corrected according to a respective merged feature and/or the respective confidence of each of the at least one initial 3D bounding box is determined according to the respective merged feature.

In the embodiments of the disclosure, for each initial 3D bounding box, the respective pooled part location information and the respective pooled point cloud semantic features may be converted to the same feature dimensions, and then the part location information and point cloud semantic features of the same feature dimensions are concatenated to implement merging of the part location information and point cloud semantic feature of the same feature dimensions.

During practical application, for each initial 3D bounding box, both the respective pooled part location information and the respective pooled point cloud semantic features may be represented by feature maps. As such, the feature maps obtained by pooling may be converted to the same feature dimensions. Then the two feature maps are merged.

In the embodiments of the disclosure, the merged feature may be an m*n*k matrix, m, n and k being positive integers. The merged feature may be used in subsequently integrating the part location information in the 3D bounding box. Thus, the confidence of the part location information in the 3D bounding box may be predicted and the 3D bounding box may be corrected, based on integration of the part location information in the initial 3D bounding box.

In the related art, after the point cloud data of the initial 3D bounding box is obtained, information of the point cloud is usually integrated by using a PointNet directly. Due to the sparsity of the point cloud, information of the initial 3D bounding box is lost due to such an operation, and this is unfavorable for integration of the 3D part location information.

In the embodiments of the disclosure, a process of correcting each of the at least one initial 3D bounding box and/or determining the confidence of each of the at least one initial 3D bounding box, according to a respective merged feature may be exemplarily implemented in the following approaches.

First Approach

For each of the at least one initial box, the respective merged feature may be vectorized to be a respective feature vector. Each of the at least one initial 3D bounding box is corrected according to the respective feature vector, and/or the confidence of each of the at least one initial 3D bounding box is determined according to the respective feature vector. During specific implementation, after the merged feature is vectorized to be the feature vector, some Fully-Connected (FC) layers are added to correct each of the at least one initial 3D bounding box and/or determine the confidence of each of the at least one initial 3D bounding box. Herein, the FC layer is a basic unit in a neural network, and may integrate category-distinctive local information in a convolution layer or a pooling layer.

Second Approach

For each of the at least one initial 3D bounding box, a sparse convolution operation may be executed to obtain a respective feature map having subjected to the sparse convolution operation. Each of the at least one initial 3D bounding box is corrected according to the respective feature map having subjected to the sparse convolution operation, and/or the confidence of each of the at least one initial 3D bounding box is determined according to the respective feature map having subjected to the sparse convolution operation. Optionally, for each of the at least one initial 3D bounding box, after the respective feature map having subjected to the sparse convolution operation is obtained, a convolution operation may be executed to aggregate features of a local scale to a global scale step by step, to implement correction of each of the at least one initial 3D bounding box and/or determination of the confidence of each of the at least one initial 3D bounding box. In a particular example, when the pooling resolution is relatively low, the second approach may be used to correct each of the at least one initial 3D bounding box and/or determine the confidence of each of the at least one initial 3D bounding box.

Third Approach

For each of the at least one initial 3D bounding box, the sparse convolution operation is executed on the respective merged feature to obtain the feature map having subjected to the sparse convolution operation, and the respective feature map having subjected to the sparse convolution operation is downsampled. Each of the at least one initial 3D bounding box is corrected according to a respective downsampled feature map, and/or the confidence of each of the at least one initial 3D bounding box is determined according to the respective downsampled feature map. Herein, each of the at least one initial 3D bounding box may be corrected and/or the confidence of each of the at least one initial 3D bounding box may be determined more effectively, by downsampling the respective feature map having subjected to the sparse convolution operation, thus computing resources may be saved on.

Optionally, after the feature map having subjected to the sparse convolution operation is obtained, the feature map having subjected to the sparse convolution operation may be downsampled through a pooling operation. For example, here, the pooling operation performed on the feature map having subjected to the sparse convolution operation is a sparse max-pooling operation.

Optionally, the feature map having subjected to the sparse convolution operation is downsampled to obtain a feature vector, for integrating the part location information.

That is, in the embodiments of the disclosure, the meshed feature may be gradually downsampled to an encoded feature vector based on the pooled part location information corresponding to each initial 3D bounding box and the pooled point cloud semantic features corresponding to each initial 3D bounding box, to integrate the 3D part location information. Then, the encoded feature vector may be used to correct each initial 3D bounding box and/or determine the confidence of each initial 3D bounding box.

To sum up, the sparse convolution operation-based integration operation for the 3D part location information is proposed in the embodiments of the disclosure, and the pooled 3D part location information of the feature in each initial 3D bounding box may be encoded layer by layer. The operation may be combined with the pooling operation sensitive to the initial 3D bounding box to better aggregate the 3D part location information to finally implement confidence prediction of the initial 3D bounding box and/or correction of the initial 3D bounding box, so as to obtain the 3D bounding box for the object.

During practical application, actions 101 to 103 may be implemented based on a processor of an electronic device. The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a controller, a microcontroller and a microprocessor. It can be understood that, for different electronic devices, other electronic components may be configured to realize functions of the processor, and no specific limits are made in the embodiments of the disclosure.

It can be seen that, according to the method for object detection provided in the embodiments of the disclosure, the point cloud semantic features may be directly obtained from the 3D point cloud data to determine the part location information of the foreground points and to further determine the 3D bounding box for the object according to the point cloud semantic features, the part location information of the foreground points and the at least one 3D bounding box, without the need to project the 3D point cloud data to a top view and obtain a box in the top view by use of a 2D detection technology. Loss of original information of a point cloud during quantification is avoided, and the shortcoming that it is difficult to detect an occluded object in the case of projecting to the top view is also overcome.

Based on the above disclosed method for object detection, the embodiments of the disclosure also disclose an intelligent driving method, which is applied to an intelligent driving device. The intelligent driving method includes that: a 3D bounding box for an object around the intelligent driving device is obtained according to any abovementioned method for object detection; and a driving policy is generated according to the 3D bounding box for the object.

In an example, the intelligent driving device includes an autonomous driving vehicle, a robot, a guide device for the blind, and the like; and in such case, the intelligent driving device may implement driving control according to the generated driving policy. In another example, the intelligent driving device includes a vehicle installed with an aided driving system; and in such case, the generated driving policy may be used to guide a driver to implement driving control over the vehicle.

The disclosure will further be described below through a specific application embodiment.

In the solution of the application embodiment, a 3D part-aware and aggregation neural network (which may be named as a Part-A² network) for performing object detection from original point cloud is proposed. A framework of the network is a new two-stage framework for point-cloud-based 3D object detection, and may consist of the following two stages: the first stage is a part-aware stage, and the second stage is a part-aggregation stage.

At first, in the part-aware stage, free supervision information may be deduced according to annotation information of a 3D box, and an initial 3D bounding box and accurate intra-object part location information are simultaneously predicted. Then, the part location information of foreground points in the same bounding box may be aggregated, thereby realizing an effective representation to encode the features of the 3D bounding box. In the part-aggregation stage, it is considered to aggregate a spatial relationship of the pooled part location information, for re-scoring (confidence scoring) the 3D bounding box and correcting the location of the 3D bounding box. A large number of experiments have been performed on a KITTI dataset, which shows that the predicted part location information of the foreground points is favorable for 3D object detection. Moreover, a method for object detection based on a 3D Part-A² network is better than a method for object detection in which a point cloud is fed as an input in the related art.

In some embodiments of the disclosure, different from a solution of performing object detection from a bird-view or a 2D image, a solution of segmenting foreground points to directly generate an initial 3D bounding box (i.e., a candidate 3D bounding box) from original point cloud is proposed. A segmentation label is obtained directly according to annotation information of a 3D box in a training dataset. However, the annotation information of the 3D box not only provides a segmentation mask, but also provides accurate intra-box part locations of all points in the 3D box. This is completely different from box annotation information in a 2D image, because some objects in the 2D image may be occluded. An inaccurate and noised intra-box part location may be generated for each pixel in an object when object detection is performed by use of a 2D ground-truth box. In contrast, the 3D intra-box part location is accurate and contains rich information and may be obtained for free, but has never been used in 3D object detection.

Based on such important discovery, the above Part-A² network is proposed in some embodiments. Specifically, in the preliminary part-aware stage, the network predicts intra-object part location information of all foreground points through learning. Annotation information of the part locations and the segmentation mask may be directly generated from manually labeled true information. Herein, the manually labeled true information may be denoted as a ground-truth. For example, the manually labeled true information may be a manually labeled 3D box. During practical implementation, a whole 3D space may be divided into small meshes, and point features are learned by use of a sparse-convolution-based 3D UNET-like neural network (a U-shaped network structure). An RPN head may be added to the U-shaped network structure to generate an initial candidate 3D bounding box, so that these parts may be aggregated, thus entering the part aggregation stage.

The part aggregation stage is intended that: given a group of points in a candidate 3D bounding box, the Part-A² network should be able to evaluate the quality of the candidate bounding box, and learn a spatial relationship of predicted intra-object part locations of all these points to optimize the candidate bounding box. Therefore, in order to group the points in the same 3D bounding box, a novel point cloud pooling module may be proposed, which may be denoted as a Region of Interest (RoI)-ware point cloud pooling module. The RoI-aware point cloud pooling module may eliminate, through a new pooling operation, the ambiguity in conducting region pooling on the point cloud. Unlike executing the pooling operation on all point clouds or non-null voxels in a pooling operation solution in the related art, the RoI-aware point cloud pooling module executes the pooling operation on all meshes (including non-null meshes and null meshes) in the 3D bounding box. This is the key to generate an effective representation for 3D bounding box scoring and location correction, because the 3D bounding box information is also encoded at the null meshes. After the pooling operation, the network may aggregate the part location information by sparse convolution and pooling operations. Experimental results show that the aggregated part features may remarkably improve the quality of the candidate bounding box and achieves the highest performance 3D detection benchmark.

Unlike performing 3D object detection based on data acquired from multiple sensors, in the application embodiment of the disclosure, the 3D part-aware and aggregation neural network may obtain a 3D detection result similar to and even better than that of the related art only by using the point cloud data as an input. Further, in the framework of the 3D part-aware and aggregation neural network, rich information provided by the annotation information of the 3D box is further exploited, and it is learned to predict accurate intra-object part location information, to improve the performance of 3D object detection. Furthermore, a backbone network with the U-shaped network structure is proposed in the application embodiment of the disclosure, and point cloud features may be extracted and recognized by sparse convolution and deconvolution, and are used to predict the intra-object part location information and implement 3D object detection.

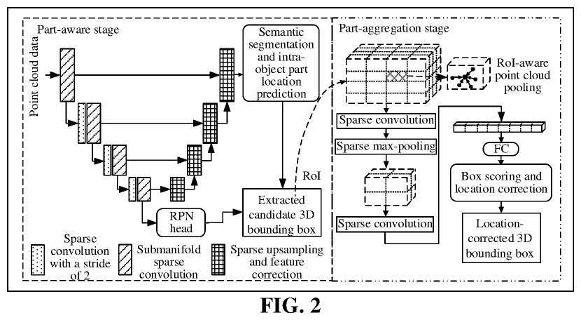

FIG. 2 illustrates a schematic diagram of a comprehensive framework of a 3D part-aware and aggregation neural network according to an application embodiment of the disclosure. As illustrated in FIG. 2, the framework of the 3D part-aware and aggregation neural network includes a part-aware stage and a part-aggregation stage. In the part-aware stage, original point cloud data may be input to a newly designed backbone network with a U-shaped network structure to accurately estimate intra-object part locations and generate candidate 3D bounding boxes. In the part-aggregation stage, a proposed pooling operation based on a RoI-aware point cloud pooling module is executed. Specifically, part information of each candidate 3D bounding box is grouped, and then a spatial relationship between various parts is considered by use of the part aggregation network, to implement scoring and location correction of the 3D bounding box.

It can be understood that, objects in a 3D space are naturally separated, and therefore, a ground-truth box in 3D object detection automatically provides an accurate intra-object part location and segmentation mask for each 3D point. This is quite different from 2D object detection. A 2D object box may only contain a part of an object due to occlusion and, consequently, may not provide an accurate intra-object part location for each 2D pixel.

The method for object detection according to the embodiments of the disclosure may be applied to multiple scenarios. In a first example, the method for object detection may be applied to 3D object detection in a autonomous driving scenario, and information of a location, size, movement direction or the like of an object around may be detected to help to make an autonomous driving decision. In a second example, 3D object tracking may be implemented by use of the method for object detection. Specifically, 3D object detection may be implemented by use of the method, for object detection at any moment, and a detection result may be taken as a basis for 3D object tracking. In a third example, a pooling operation may be executed on a point cloud in a 3D bounding box by use of the method for object detection. Specifically, sparse point cloud in each different 3D bounding box may be pooled to be a 3D bounding box feature with a fixed resolution.

Based on such important discovery, the Part-A² network for 3D object detection from the point cloud is proposed in the application embodiment of the disclosure. Specifically, 3D part location labels and segmentation labels are introduced as additional supervision information to facilitate generation of the candidate 3D bounding boxes. In the part aggregation stage, the predicted 3D intra-object part location information in each candidate 3D bounding box is aggregated, for scoring and location correction of the candidate bounding box.

A flow of the application embodiment of the disclosure will be specifically described below.

At first, it is possible to learn to predict intra-object part location information of 3D points. Specifically, as illustrated in FIG. 2, a U-shaped network structure is designed in the application embodiment of the disclosure, and sparse convolution and sparse deconvolution may be performed on obtained sparse meshes to learn point-wise feature representations of foreground points. In FIG. 2, three sparse convolution operations with a stride of 2 may be executed on point cloud data; as such, a spatial resolution of the point cloud may be reduced to ⅛ of an initial spatial resolution by downsampling. Each sparse convolution operation includes some submanifold sparse convolutions. Herein, the stride of the sparse convolution operation may be determined according to a spatial resolution needing to be achieved by the point cloud data. For example, if the spatial resolution needing to be achieved by the point cloud data is lower, the stride of the sparse convolution operation needs to be set longer. After the three sparse convolution operations are executed on the point cloud data, sparse upsampling and feature correction are performed on a feature obtained after the three sparse convolution operations. In the embodiments of the disclosure, a sparse operation based upsampling block (configured to execute a sparse upsampling operation) may be configured to correct a fused feature and save computing resources.

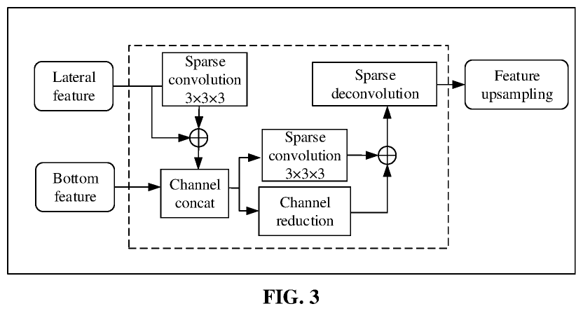

Sparse upsampling and feature correction may be implemented based on a sparse upsampling and feature correction module. FIG. 3 illustrates a block diagram of a sparse upsampling and feature correction module according to an application embodiment of the disclosure. The module is applied to a decoder of the backbone network with the sparse-convolution-based U-shaped network structure. Referring to FIG. 3, a lateral feature and a bottom feature are fused at first by sparse convolution, and then feature upsampling is performed on a fused feature by sparse deconvolution. In FIG. 3, “sparse convolution 3×3×3” represents sparse convolution with a convolution kernel size of 3×3×3, “channel concat” represents concatenation of feature vectors in a channel direction, “channel reduction” represents reduction of the feature vectors in the channel direction, “⊕” represents addition of the feature vectors in the channel direction. It can be seen that, referring to FIG. 3, operations such as sparse convolution, channel concat, channel reduction, sparse deconvolution and the like may be executed for the lateral feature and the bottom feature, realizing feature correction of the lateral feature and the bottom feature.

Referring to FIG. 2, after sparse upsampling and feature correction are performed on the feature obtained after the three sparse convolution operations, semantic segmentation and intra-object part location prediction may further be performed on the feature having subjected to sparse upsampling and feature correction.

When an object is recognized and detected by use of a neural network, intra-object part location information is essential. For example, a side surface of a vehicle is also a plane perpendicular to the ground, and two wheels are always close to the ground. The neural network develops a capability of deducing a shape and pose of the object by learning and estimating a foreground segmentation mask and intra-object part location of each point, which is favorable for 3D object detection.

During particular implementation, two branches may be added based on the backbone network of the sparse convolution based U-shaped network structure, to segment foreground points and predict intra-object part locations thereof respectively. When the intra-object part locations of the foreground points are predicted, the prediction may be conducted based on annotation information of a 3D box in a training dataset. In the training dataset, all points in or outside a ground-truth box are taken as positive and negative samples for training.

The 3D ground-truth box automatically provides 3D part location labels. The part label (pₓ, p_{y}, p_{z}) of the foreground point is a known parameter. Herein, (pₓ, p_{y}, P_{z}) may be converted into a part location label (Oₓ, O_{y}, O_{z}) to represent a relative location thereof in the corresponding object. The 3D box is represented by (Cₓ, C_{y}, Cₓ, h, w, l, θ), where (Cₓ, C_{y}, C_{z}) represents a center location of the 3D box, (h, w, l) represents a size of a bird-view corresponding to the 3D box, and θ represents a direction of the 3D box in the corresponding bird-view, i.e., an included angle between an orientation of the 3D box in the corresponding bird-view and an X-axis direction in the bird-view. The part location label (Ox, Oy, Oz) may be calculated through the following formula (1):

$$[ {t}_{x} {t}_{y} ] = [ {p}_{x} - {C}_{x} {p}_{y} - {C}_{y} ] [ \begin{matrix}c os ( - θ ) & - s in ( - θ ) \\ s in ( - θ ) & c os ( - θ )\end{matrix} ] \\ {O}_{x} = \frac{{t}_{x}}{w} + 0.5 , {O}_{y} = \frac{{t}_{y}}{l} + 0.5 , {O}_{z} = \frac{{p}_{z} - {O}_{z}}{h} + 0.5 \qquad ( 1 )$$

Oₓ, O_{y}, O_{z}∈[0,1], a part location of an object center is (0.5, 0.5, 0.5). Herein, all coordinates involved in the formula (1) are represented in a LiDAR coordinate system of the KITTI. The z direction is perpendicular to the ground, and the x and y directions are on the horizontal plane.

Herein, the 3D part location of the foreground point may be learned by taking a binary cross entropy loss as a part regression loss, and an expression thereof is as follows:

Lₚₐᵣₜ(Pᵤ)=−(Oᵤ log(Pᵤ)+(1−Oᵤ)log(1−Pᵤ)),u∈{x,y,z} (2).

Pᵤ represents a predicted intra-object part location after a sigmoid layer, and Lₚₐᵣₜ(Pᵤ) represents the predicted part location information of the 3D point. Herein, part location prediction may be performed on foreground points only.

In the application embodiment of the disclosure, candidate 3D bounding boxes may also be generated. Specifically, for aggregating the predicted intra-object part locations for 3D object detection, the candidate 3D bounding boxes need to be generated to aggregate intra-object part information of the estimated foreground points from the same object. During practical implementation, as illustrated in FIG. 2, the same RPN head is added to a feature map generated by a sparse convolution encoder (i.e., a feature map obtained by executing three sparse convolution operations on the point cloud data). For generating the candidate 3D bounding box, the feature map is downsampled by 8 times, and features at different heights of the same bird-view location are aggregated to generate a 2D bird-view feature map configured to generate the candidate 3D bounding box.

Referring to FIG. 2, for the extracted candidate 3D bounding box, the pooling operation may be executed in the part-aggregation stage. For an implementation of the pooling operation, in some embodiments, a region pooling operation for point cloud is proposed. The pooling operation may be executed on the point-wise features in the candidate 3D bounding box, and then the candidate 3D bounding box is corrected based on the feature map having subjected to the pooling operation. However, such a pooling operation may cause information loss of the candidate 3D bounding box because the points in the candidate 3D bounding box are irregularly distributed, and there is an ambiguity in recovering the 3D bounding box from the pooled points.

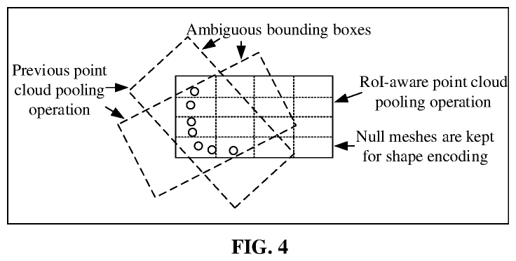

FIG. 4 illustrates a schematic diagram of a point cloud pooling operation according to an application embodiment of the disclosure. As illustrated in FIG. 4, the previous point cloud pooling operation represents the point cloud region pooling operation disclosed above, and a circle represents a pooled point. It can be seen that, if the point cloud region pooling operation disclosed above is used, different candidate 3D bounding boxes result in the same pooled points. That is, there is an ambiguity for the point cloud region pooling operation disclosed above, making it impossible to recover the shape of the initial candidate 3D bounding box by use of the previous point cloud pooling method, thus bringing negative influence to subsequent correction of the candidate bounding box.

For the implementation of the pooling operation, in some other embodiments, a RoI-aware point cloud pooling operation is proposed. A specific process of the RoI-aware point cloud pooling operation is as follows: each candidate 3D bounding box is uniformly divided into multiple meshes; if any of the multiple meshes contains no foreground point, this mesh is a null mesh, and in such case, part location information of this mesh is labeled to be null and a point cloud semantic feature of this mesh is set to be 0; and uniform pooling is performed on part location information of a foreground point in each mesh and max-pooling processing is performed on a clout point semantic feature of the foreground point in each mesh, to obtain pooled part location information and cloud point semantic features of each candidate 3D bounding box.

It can be understood that, in combination with FIG. 4, the RoI-aware point cloud pooling operation may encode the shape of the candidate 3D bounding box by keeping null meshes, and the shape (null mesh) of the candidate bounding box may be processed effectively by the sparse convolution.

That is, for a particular implementation of the RoI-aware point cloud pooling operation, the candidate 3D bounding box may be uniformly divided into regular meshes in a fixed spatial shape (H*W*L), where H, W and L represent height, width and length hyperparameters of the pooling resolution in each dimension respectively and are unrelated to the size of the candidate 3D bounding box. The feature of each mesh is calculated by aggregating (for example, max-pooling or uniform pooling) point features in the mesh. It can be seen that, based on the RoI-aware point cloud pooling operation, different candidate 3D bounding boxes may be normalized to the same local spatial coordinates, and the feature at the corresponding fixed position in the candidate 3D bounding box is encoded at each mesh, which is more significant for encoding of the candidate 3D bounding box and favorable for subsequent scoring and location correction of the candidate 3D bounding box.

After the pooled part location information and point cloud semantic features of the candidate 3D bounding box are obtained, part location aggregation for correcting the candidate 3D bounding box may further be executed.

Specifically, considering the spatial distribution of predicted intra-object part locations of all 3D points in a candidate 3D bounding box, it may be considered that it is reasonable to evaluate the quality of the candidate 3D bounding box by aggregating the part locations. A problem of part location aggregation may be represented as an optimization problem, and the predicted part locations of all the points in the corresponding candidate 3D bounding box may be fitted to directly solve a parameter of the 3D bounding box. However, this mathematical method is sensitive to outliers and the quality of a predicted part offset.

To solve this problem, a learning-based method is proposed in the application embodiment of the disclosure, in which the part location information may be reliably aggregated for scoring (i.e., confidence) and location correction of the candidate 3D bounding box. For each candidate 3D bounding box, the proposed RoI-aware point cloud pooling operation is applied to the part location information and point cloud semantic features of the candidate 3D bounding box respectively, thereby generating two feature maps with sizes of (14*14*14*14) and (14*14*14*C). The predicted part location information corresponds to a four-dimensional map. In the four-dimensional map, three dimensions represent XYZ dimensions and are configured to represent the part location, and the other dimension represents a foreground segmentation fraction. C represents the feature size of the point-wise features obtained in the part-aware stage.

After the pooling operation, as illustrated in FIG. 2, in the part-aggregation stage, learning from the spatial distribution of the predicted intra-object part locations may be realized in a layered manner Specifically, the two pooled feature maps (including the pooled part location information and point cloud semantic features of the candidate 3D bounding box) are converted to the same feature dimensions at first by use of a sparse convolution layer with a kernel size of 3*3*3; then the two feature maps of the same feature dimension are concatenated; and for a concatenated feature map, four sparse convolution layers with a kernel size of 3*3*3 may be stacked to execute a sparse convolution operation. Along with the enlargement of a receptive field, the part information may be gradually aggregated. During practical implementation, after the pooled feature maps are converted into the feature maps of the same feature dimensions, a sparse max-pooling operation based on a kernel size of 2*2*2 and a stride of 2*2*2 may be used to downsample resolutions of the feature maps to 7*7*7 to save computing resources and parameters. After the four sparse convolutional layers with the kernel size of 3*3*3 are stacked to execute the sparse convolution operation, the feature map obtained by the sparse convolution operation may further be vectorized (corresponding to FC in FIG. 2) to obtain a feature vector. After the feature vector is obtained, two branches may be added to perform final scoring of the candidate 3D bounding box and location correction of the candidate 3D bounding box. Exemplarily, scoring of the candidate 3D bounding box represents confidence scoring of the candidate 3D bounding box, and confidence scoring of the candidate 3D bounding box at least represents scoring of the part location information of the foreground points in the candidate 3D bounding box.

Compared with a method of directly vectorizing the pooled 3D feature map to be the feature vector, an execution process of the part aggregation stage proposed in the application embodiment of the disclosure has the advantages that the features may be aggregated effectively from the local scale to the global scale and thus it is able to learn to predict the spatial distribution of the part locations. By sparse convolution, many computing resources and parameters are saved, because the pooled meshes are quite sparse, and cannot be ignored in the related art (namely the part locations may not be aggregated by sparse convolution) due to that it is necessary to encode each mesh to be a feature at a specific position in the candidate 3D bounding box in the related art.

It can be understood that, referring to FIG. 2, after location correction of the candidate 3D bounding box, a location corrected 3D bounding box is obtained, namely the final 3D bounding box that can be used for 3D object detection is obtained.

In the application embodiment of the disclosure, two branches may be added to the vectorized feature vector aggregated from the predicted part information. For the branch for scoring (i.e., the confidence) of the candidate 3D bounding box, a 3D Intersection Over Union (IOU) between the candidate 3D bounding box and the corresponding ground-truth box may be used as a soft label for quality evaluation of the candidate 3D bounding box, and scoring of the candidate 3D bounding box may also be learned according to the formula (2) by use of the binary cross entropy loss.

For generation and location correction of the candidate 3D bounding box, an object regression solution may be employed, and a normalized box parameter is regressed by use of a smooth-L1 loss. A specific implementation process is illustrated in the formula (3).

$$Δ x = \frac{{x}^{g} - {x}^{a}}{{d}^{a}} , Δ y = \frac{{y}^{g} - {y}^{a}}{{h}^{a}} , Δ z = \frac{{z}^{g} - {z}^{a}}{{d}^{a}} \\ Δ l = log ( \frac{{l}^{g}}{{l}^{a}} ) , Δ h = log ( \frac{{h}^{g}}{{h}^{a}} ) , Δ w = log ( \frac{{w}^{g}}{{w}^{a}} ) \\ Δ θ = {θ}^{g} - {θ}^{a} , {d}^{a} = \sqrt{{( {l}^{a} )}^{2} + {( {w}^{a} )}^{2}} \qquad ( 3 )$$

Δx, Δy and Δz represent offsets of the center location of the 3D box respectively, Δh, Δw and Δl represent offsets of the size of the bird-view corresponding to the 3D box respectively, Δθ represents a direction offset of the bird-view corresponding to the 3D box, d^{a} represents a center offset in a standard bird-view, x^{a}, y^{a} and z^{a} represent a center location of an anchor/candidate 3D bounding box, h^{a}, w^{a} and l^{a} represent the size of a bird-view corresponding to the anchor/candidate 3D bounding box, θ^{a} represents a direction of the bird-view corresponding to the anchor/candidate 3D bounding box, x^{g}, y^{g} and z^{g} represent a center location of the corresponding ground-truth box, h^{g}, w^{g} and l^{g} represent the size of a bird-view corresponding to the ground-truth box, and θ^{g} represents a direction of the bird-view corresponding to the ground-truth box.

Unlike the candidate bounding box correction method in the related art, for location correction of the candidate 3D bounding box in the application embodiment of the disclosure, regression for a relative offset or size ratio may be performed directly according to the parameter of the candidate 3D bounding box because the RoI-aware point cloud pooling module has encoded all the shared information of the candidate 3D bounding box and transferred different candidate 3D bounding boxes to the same normalized spatial coordinate system.

It can be seen that there are three losses in the part-aware stage with an equal loss weight 1, including a focal loss for foreground point segmentation, the binary cross entropy loss for regression of the intra-object part location and the smooth-L1 loss for generation of the candidate 3D bounding box. For the part aggregation stage, there are two losses with an equal loss weight, including the binary cross entropy loss for IOU regression and the smooth-L1 loss for location correction.

To sum up, a new method for 3D object detection is proposed in the application embodiment of the disclosure. A 3D object is detected from the point cloud by use of the Part-A² network. In the part-aware stage, the accurate intra-object part locations are estimated by learning with the location labels from the 3D boxes, and the predicted part locations of each object are grouped through a new RoI-aware point cloud pooling module. Therefore, in the part aggregation stage, the spatial relationship of the predicted intra-object part locations may be considered to score the candidate 3D bounding boxes and correct locations thereof. Experiments show that, by the method for object detection according to the application embodiment of the disclosure, the highest performance is achieved on the challenging KITTI 3D detection benchmark and the method proves to be effective.

It can be understood by those skilled in the art that, in the method of the detailed description, the writing sequence of the actions does not mean a strict execution sequence and is not intended to form any limit to the implementation process, and a specific execution sequence of the actions should be determined by functions and possible internal logic thereof.

Based on the method for object detection disclosed in the abovementioned embodiments, an apparatus for object detection is disclosed in the embodiments of the disclosure.

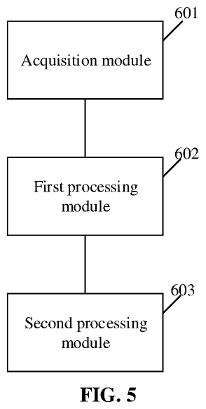

FIG. 5 illustrates a schematic diagram of a compositional structure of an apparatus for object detection according to embodiments of the disclosure. As illustrated in FIG. 5, the apparatus is provided in an electronic device. The apparatus includes an acquisition module 601, a first processing module 602 and a second processing module 603.

The acquisition module 601 is configured to acquire three-dimensional (3D) point cloud data and determine point cloud semantic features corresponding to the 3D point cloud data according to the 3D point cloud data.

The first processing module 602 is configured to determine part location information of foreground points based on the point cloud semantic features. The foreground points represent point cloud data belonging to an object in the 3D point cloud data, and the part location information of the foreground points indicates a relative location of each of the foreground points in the object. The first processing module 602 is configured to extract at least one initial 3D bounding box based on the 3D point cloud data.

The second processing module 603 is configured to determine a 3D bounding box for the object according to the point cloud semantic features corresponding to the 3D point cloud data, the part location information of the foreground points, and the at least one initial 3D bounding box. The object exists in a region in the 3D bounding box.

In an implementation, the second processing module 603 is configured to: for each of the at least one initial 3D bounding box, execute a pooling operation on respective part location information of foreground points and respective point cloud semantic features, to obtain respective pooled part location information and respective pooled point cloud semantic features; and perform at least one of the following so as to determine the 3D bounding box for the object: correcting each of the at least one initial 3D bounding box according to the respective pooled part location information and the respective pooled point cloud semantic features, or determining a respective confidence of each of the at least one initial 3D bounding box according to the respective pooled part location information and the respective pooled point cloud semantic features.

In an implementation, the second processing module 603 is configured to: uniformly divide each of the at least one initial 3D bounding box into a plurality of meshes, and execute, for each of the plurality of meshes, the pooling operation on respective part location information of the foreground points and a respective point cloud semantic feature, to obtain, for each of the at least one initial 3D bounding box, the respective pooled part location information and the respective pooled point cloud semantic features; and performing at least one of the following so as to determine the 3D bounding box for the object: correcting each of the at least one initial 3D bounding box according to the respective pooled part location information and the respective pooled point cloud semantic features, or determining the respective confidence of each of the at least one initial 3D bounding box according to the respective pooled part location information and the respective pooled point cloud semantic features.

In an implementation, in executing, for each of the plurality of meshes, the pooling operation on the respective part location information of the foreground points and the respective point cloud semantic feature, the second processing module 603 is configured to: in response to that there is no foreground point in one of the plurality of meshes, label part location information of the mesh to be null, and set a point cloud semantic feature of the mesh to be 0 to obtain a pooled point cloud semantic feature of the mesh; or in response to that there is at least one foreground point in one of the plurality of meshes, perform uniform pooling operation on part location information of the foreground points in the mesh to obtain pooled part location information of the foreground points in the mesh, and perform max-pooling on a point cloud semantic feature of the foreground points in the mesh to obtain a pooled point cloud semantic feature of the mesh.

In an implementation, the second processing module 603 is configured to: for each of the at least one initial 3D bounding box, execute the pooling operation on the respective part location information of the foreground points and the respective point cloud semantic features, to obtain the respective pooled part location information and the respective pooled point cloud semantic features; and merge, for each of the at least one initial 3D bounding box, the respective pooled part location information with the respective pooled point cloud semantic features, and perform at least one of: correcting each of the at least one initial 3D bounding box according to a respective merged feature, or determining the respective confidence of each of the at least one initial 3D bounding box according to the respective merged feature.

In an implementation, in performing at least one of: correcting each of the at least one initial 3D bounding box according to the respective merged feature, or determining the respective confidence of each of the at least one initial 3D bounding box according to the respective merged feature, the second processing module 603 is configured to: for each of the at least one initial 3D bounding box, vectorize the respective merged feature to be a respective feature vector, and perform at least one of: correcting each of the at least one initial 3D bounding box according to the respective feature vector, or determining the respective confidence of each of the at least one initial 3D bounding box according to the respective feature vector; or for each of the at least one initial 3D bounding box, execute a sparse convolution operation on the respective merged feature to obtain a respective feature map having subjected to the sparse convolution operation, and perform at least one of: correcting each of the at least one initial 3D bounding box according to the respective feature map having subjected to the sparse convolution operation, or determining the respective confidence of each of the at least one initial 3D bounding box, according to the respective feature map having subjected to the sparse convolution operation; or for each of the at least one initial 3D bounding box, execute the sparse convolution operation on the respective merged feature to obtain the respective feature map having subjected to the sparse convolution operation, downs ample the respective feature map having subjected to the sparse convolution operation, and perform at least one of: correcting each of the at least one initial 3D bounding box according to a respective downsampled feature map, or determining the respective confidence of each of the at least one initial 3D bounding box according to the respective downsampled feature map.

In an implementation, in downsampling the respective feature map having subjected to the sparse convolution operation, the second processing module 603 is configured to: execute a pooling operation on the respective feature map having subjected to the sparse convolution operation for downsampling the respective feature map having subjected to the sparse convolution operation.

In an implementation, the acquisition module 601 is configured to: acquire the 3D point cloud data; and perform 3D meshing on the 3D point cloud data to obtain 3D meshes, and extract each of the point cloud semantic features corresponding to the 3D point cloud data from a respective non-null mesh among the 3D meshes.

In an implementation, in determining the part location information of the foreground points based on the point cloud semantic features, the first processing module 602 is configured to: segment, according to the point cloud semantic features, a foreground from a background in the point cloud data to determine the foreground points. The foreground points are point cloud data belonging to the object in the point cloud data. The first processing module 602 is configured to: process, by a neural network, the determined foreground points to obtain the part location information of the foreground points. The neural network is configured to predict the part location information of the foreground points. The neural network is trained by using a training dataset including annotation information of a 3D box. The annotation information of the 3D box at least includes part location information of foreground points in point cloud data in the training dataset.

In the method for object detection, the intelligent driving method, the apparatus for object detection, the electronic device and the computer storage medium disclosed in the embodiments of the disclosure: three-dimensional (3D) point cloud data is acquired; point cloud semantic features corresponding to the 3D point cloud data are determined according to the 3D point cloud data; part location information of foreground points is determined based on the point cloud semantic features, wherein the foreground points represent point cloud data belonging to an object in the 3D point cloud data, and the part location information of the foreground points indicates a relative location of each of the foreground points in the object; at least one initial 3D bounding box is extracted based on the 3D point cloud data; and a 3D bounding box for the object is determined according to the point cloud semantic features corresponding to the 3D point cloud data, the part location information of the foreground points, and the at least one initial 3D bounding box, wherein the object exists in a region in the 3D bounding box. In this way, the point cloud semantic feature is directly obtained from the 3D point cloud data to determine the part location information of the foreground points, and the 3D bounding box for the object is further determined according to the point cloud semantic features, the part location information of the foreground points and the at least one 3D bounding box. There is no need to project the 3D point cloud data to a top view and obtain a box in the top view by use of a two-dimensional (2D) detection technology. Loss of original information of a point cloud is avoided during quantification, and the shortcoming that it is difficult to detect an occluded object during projection to the top view is also overcome.

In addition, various functional modules in the embodiment may be integrated into a processing unit, each unit may also exist independently, and two or more units may also be integrated into one unit. The integrated unit may be implemented in a hardware form and may also be implemented in form of software function module.

When implemented in form of software function module and sold or used not as an independent product, the integrated unit may be stored in a computer-readable storage medium. Based on such an understanding, the technical solution of the embodiment substantially or parts making contributions to the conventional art or all or part of the technical solution may be embodied in form of software product, and the computer software product is stored in a storage medium, including a plurality of instructions configured to enable a computer device (which may be a personal computer, a server, a network device or the like) or a processor to execute all or part of the actions of the method in the embodiment. The storage medium includes various media capable of storing program codes such as a USB flash disk, a mobile Hard Disk Drive (HDD), a Read-Only Memory (ROM), a Random Access Memory (RAM), a magnetic disk or an optical disk.

Specifically, computer program instructions corresponding to any method for object detection or intelligent driving method in the embodiment may be stored in a storage medium such as an optical disk, an HDD or a U disk, and the computer program instructions corresponding to any method for object detection or intelligent driving method in the storage medium is read or executed by an electronic device to implement any method for object detection or intelligent driving method of the abovementioned embodiments.

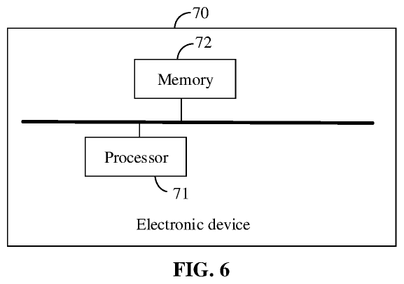

Based on the same technical concept of the abovementioned embodiments, referring to FIG. 6 which illustrates an electronic device 70 provided in the embodiments of the disclosure, which may include a memory 71 and a processor 72.

The memory 71 is configured to store a computer program and data.

The processor 72 is configured to execute the computer program stored in the memory to implement any method for object detection or intelligent driving method of the abovementioned embodiments.

During practical application, the memory 71 may be a volatile memory such as a RAM, or a non-volatile memory such as a ROM, a flash memory, an HDD or a Solid-State Drive (SSD), or a combination of the memories, and provides instructions and data for the processor 72.

The processor 72 may be at least one of an application-specific integrated circuit (ASIC), a digital signal processor (DSP), a digital signal processor device (DSPD), a programmable logic device (PLD), a field programmable gate array (FPGA), a central processing unit (CPU), a controller, a microcontroller and a microprocessor. It can be understood that, for different devices, other electronic components may be configured to realize functions of the processor, and no specific limits are made in the embodiment of the disclosure.

The embodiments of the disclosure also disclose a computer storage medium having stored thereon a computer program that, when being executed by a processor, implements any above method for object detection.

The embodiments of the disclosure also provide a computer program product including computer-executable instructions. The computer-executable instructions, when being executed, can implement any method for object detection provided in the embodiments of the disclosure.

In some embodiments, functions or modules of the device provided in the embodiment of the disclosure may be configured to execute the method described in the above method embodiment and specific implementation thereof may refer to the descriptions about the method embodiment and, for simplicity, will not be elaborated herein.

The above descriptions about the embodiments focus on differences between each embodiment and the same or similar parts may refer to each other and will not be elaborated herein for simplicity.

The methods disclosed in each method embodiment provided in the disclosure may be freely combined without conflicts to obtain new method embodiments.

The characteristics disclosed in each product embodiment provided in the disclosure may be freely combined without conflicts to obtain new product embodiments.

The characteristics disclosed in each method or device embodiment provided in the disclosure may be freely combined without conflicts to obtain new method embodiments or device embodiments.

From the above descriptions about the implementations, those skilled in the art may clearly know that the method of the abovementioned embodiments may be implemented in a manner of combining software and a necessary universal hardware platform, and of course, may also be implemented through hardware, but the former is a preferred implementation under many circumstances. Based on such an understanding, the technical solutions of the disclosure substantially or parts making contributions to the conventional art may be embodied in form of software product, and the computer software product is stored in a storage medium (for example, a ROM/RAM, a magnetic disk and an optical disk), including a plurality of instructions configured to enable a terminal (which may be a mobile phone, a server, an air conditioner, a network device or the like) to execute the method in each embodiment of the disclosure.

The embodiments of the disclosure are described above in combination with the drawings, but the disclosure is not limited to the abovementioned specific implementations. The abovementioned specific implementations are not restrictive but only schematic, those of ordinary skill in the art may be inspired by the disclosure to implement many forms without departing from the purpose of the disclosure and the scope of protection of the claims, and all these shall fall within the scope of protection of the disclosure.

1. A method for object detection, comprising:
acquiring three-dimensional (3D) point cloud data;
determining point cloud semantic features corresponding to the 3D point cloud data according to the 3D point cloud data;
determining part location information of foreground points based on the point cloud semantic features, wherein the foreground points represent point cloud data belonging to an object in the 3D point cloud data, and the part location information of the foreground points indicates a relative location of each of the foreground points in the object;
extracting at least one initial 3D bounding box based on the 3D point cloud data; and
determining a 3D bounding box for the object according to the point cloud semantic features corresponding to the 3D point cloud data, the part location information of the foreground points, and the at least one initial 3D bounding box, wherein the object exists in a region in the 3D bounding box.

2. The method of claim 1, wherein determining the 3D bounding box for the object according to the point cloud semantic features corresponding to the 3D point cloud data, the part location information of the foreground points, and the at least one initial 3D bounding box comprises:
for each of the at least one initial 3D bounding box, executing a pooling operation on respective part location information of foreground points and respective point cloud semantic features, to obtain respective pooled part location information and respective pooled point cloud semantic features; and
performing at least one of the following so as to determine the 3D bounding box for the object: correcting each of the at least one initial 3D bounding box according to the respective pooled part location information and the respective pooled point cloud semantic features, or determining a respective confidence of each of the at least one initial 3D bounding box according to the respective pooled part location information and the respective pooled point cloud semantic features.

3. The method of claim 2, wherein for each of the at least one initial 3D bounding box, executing the pooling operation on the respective part location information of the foreground points and the respective point cloud semantic features, to obtain the respective pooled part location information and the respective pooled point cloud semantic features comprises:
uniformly dividing each of the at least one initial 3D bounding box into a plurality of meshes, and executing, for each of the plurality of meshes, the pooling operation on respective part location information of the foreground points and a respective point cloud semantic feature, to obtain, for each of the at least one initial 3D bounding box, the respective pooled part location information and the respective pooled point cloud semantic features.

4. The method of claim 3, wherein executing, for each of the plurality of meshes, the pooling operation on the respective part location information of the foreground points and the respective point cloud semantic feature comprises:
in response to that there is no foreground point in one of the plurality of meshes, labeling part location information of the mesh to be null, and setting a point cloud semantic feature of the mesh to be 0 to obtain a pooled point cloud semantic feature of the mesh; or
in response to that there is at least one foreground point in one of the plurality of meshes, performing uniform pooling operation on part location information of the foreground points in the mesh to obtain pooled part location information of the foreground points in the mesh, and performing max-pooling on a point cloud semantic feature of the foreground points in the mesh to obtain a pooled point cloud semantic feature of the mesh.

5. The method of claim 2, wherein performing at least one of the following: correcting each of the at least one initial 3D bounding box according to the respective pooled part location information and the respective pooled point cloud semantic features, or determining the respective confidence of each of the at least one initial 3D bounding box according to the respective pooled part location information and the respective pooled point cloud semantic features comprises:
merging, for each of the at least one initial 3D bounding box, the respective pooled part location information with the respective pooled point cloud semantic features, and performing at least one of: correcting each of the at least one initial 3D bounding box according to a respective merged feature, or determining the respective confidence of each of the at least one initial 3D bounding box according to the respective merged feature.

6. The method of claim 5, wherein performing at least one of: correcting each of the at least one initial 3D bounding box according to the respective merged feature, or determining the respective confidence of each of the at least one initial 3D bounding box according to the respective merged feature comprises one of:
for each of the at least one initial 3D bounding box, vectorizing the respective merged feature to be a respective feature vector, and performing at least one of: correcting each of the at least one initial 3D bounding box according to the respective feature vector, or determining the respective confidence of each of the at least one initial 3D bounding box according to the respective feature vector; or
for each of the at least one initial 3D bounding box, executing a sparse convolution operation on the respective merged feature to obtain a respective feature map having subjected to the sparse convolution operation, and performing at least one of: correcting each of the at least one initial 3D bounding box according to the respective feature map having subjected to the sparse convolution operation, or determining the respective confidence of each of the at least one initial 3D bounding box according to the respective feature map having subjected to the sparse convolution operation; or
for each of the at least one initial 3D bounding box, executing the sparse convolution operation on the respective merged feature to obtain the respective feature map having subjected to the sparse convolution operation, downsampling the respective feature map having subjected to the sparse convolution operation, and performing at least one of: correcting each of the at least one initial 3D bounding box according to a respective downsampled feature map, or determining the respective confidence of each of the at least one initial 3D bounding box according to the respective downsampled feature map.

7. The method of claim 6, wherein downsampling the respective feature map having subjected to the sparse convolution operation comprises:
executing a pooling operation on the respective feature map having subjected to the sparse convolution operation for downsampling the respective feature map having subjected to the sparse convolution operation.

8. The method of claim 1, wherein determining the point cloud semantic features corresponding to the 3D point cloud data according to the 3D point cloud data comprises:
performing 3D meshing on the 3D point cloud data to obtain 3D meshes, and extracting each of the point cloud semantic features corresponding to the 3D point cloud data from a respective non-null mesh among the 3D meshes.

9. The method of claim 1, wherein determining the part location information of the foreground points based on the point cloud semantic features comprises:
segmenting, according to the point cloud semantic features, a foreground from a background in the point cloud data to determine the foreground points, wherein the foreground points are point cloud data belonging to the object in the point cloud data; and
processing, by a neural network, the determined foreground points to obtain the part location information of the foreground points, wherein the neural network is configured to predict the part location information of the foreground points,
wherein the neural network is trained by using a training dataset comprising annotation information of a 3D box, and the annotation information of the 3D box at least comprises part location information of foreground points in point cloud data in the training dataset.

10. An intelligent driving method, applied to an intelligent driving device and comprising:
obtaining a three-dimensional (3D) bounding box for an object around the intelligent driving device according to the method for object detection of claim 1; and
generating a driving policy according to the 3D bounding box for the object.

11. An apparatus for object detection, comprising:
a processor; and
a memory configured to store instructions which when being executed by the processor, cause the processor to carry out the following:
acquiring three-dimensional (3D) point cloud data and determine point cloud semantic features corresponding to the 3D point cloud data according to the 3D point cloud data;
determining part location information of foreground points based on the point cloud semantic features, wherein the foreground points represent point cloud data belonging to an object in the 3D point cloud data, and the part location information of the foreground points indicates a relative location of each of the foreground points in the object, and extract at least one initial 3D bounding box based on the 3D point cloud data; and
determining a 3D bounding box for the object according to the point cloud semantic features corresponding to the 3D point cloud data, the part location information of the foreground points, and the at least one initial 3D bounding box, wherein the object exists in a region in the 3D bounding box.

12. The apparatus of claim 11, wherein the instructions, when being executed by the processor, cause the processor to carry out the following:
for each of the at least one initial 3D bounding box, executing a pooling operation on respective part location information of foreground points and respective point cloud semantic features, to obtain respective pooled part location information and respective pooled point cloud semantic features; and
according to the respective pooled part location information and the respective pooled point cloud semantic features, performing at least one of the following so as to determine the 3D bounding box for the object: correcting each of the at least one initial 3D bounding box according to the respective pooled part location information and the respective pooled point cloud semantic features, or determining a respective confidence of each of the at least one initial 3D bounding box according to the respective pooled part location information and the respective pooled point cloud semantic features.

13. The apparatus of claim 12, wherein the instructions, when being executed by the processor, cause the processor to carry out the following:
uniformly dividing each of the at least one initial 3D bounding box into a plurality of meshes, and executing, for each of the plurality of meshes, the pooling operation on respective part location information of the foreground points and a respective point cloud semantic feature, to obtain, for each of the at least one initial 3D bounding box, the respective pooled part location information and the respective pooled point cloud semantic features; and
performing at least one of the following so as to determine the 3D bounding box for the object: correcting each of the at least one initial 3D bounding box according to the respective pooled part location information and the respective pooled point cloud semantic features, or determining the respective confidence of each of the at least one initial 3D bounding box according to the respective pooled part location information and the respective pooled point cloud semantic features.

14. The apparatus of claim 13, wherein, in executing, for each of the plurality of meshes, the pooling operation on the respective part location information of the foreground points and the respective point cloud semantic feature, the instructions, when being executed by the processor, cause the processor to carry out the following:
in response to that there is no foreground point in one of the plurality of meshes, labelling part location information of the mesh to be null, and setting a point cloud semantic feature of the mesh to be 0 to obtain a pooled point cloud semantic feature of the mesh; or
in response to that there is at least one foreground point in one of the plurality of meshes, performing uniform pooling operation on part location information of the foreground points in the mesh to obtain pooled part location information of the foreground points in the mesh, and performing max-pooling on a point cloud semantic feature of the foreground points in the mesh to obtain a pooled point cloud semantic feature of the mesh.

15. The apparatus of claim 12, wherein the instructions, when being executed by the processor, cause the processor to carry out the following:
for each of the at least one initial 3D bounding box, executing the pooling operation on the respective part location information of the foreground points and the respective point cloud semantic feature, to obtain the respective pooled part location information and the respective pooled point cloud semantic features; and
merging, for each of the at least one initial 3D bounding box, the respective pooled part location information with the respective pooled point cloud semantic features, and performing at least one of: correcting each of the at least one initial 3D bounding box according to a respective merged feature, or determining the respective confidence of each of the at least one initial 3D bounding box according to the respective merged feature.

16. The apparatus of claim 15, wherein, in performing at least one of: correcting each of the at least one initial 3D bounding box according to the respective merged feature, or determining the respective confidence of each of the at least one initial 3D bounding box according to the respective merged feature, the instructions, when being executed by the processor, cause the processor to carry out the following:
for each of the at least one initial 3D bounding box, vectorizing the respective merged feature to be a respective feature vector, and performing at least one of: correcting each of the at least one initial 3D bounding box according to the respective feature vector, or determining the respective confidence of each of the at least one initial 3D bounding box according to the respective feature vector; or
for each of the at least one initial 3D bounding box, executing a sparse convolution operation on the respective merged feature to obtain a respective feature map having subjected to the sparse convolution operation, and performing at least one of: correcting each of the at least one initial 3D bounding box according to the respective feature map having subjected to the sparse convolution operation, or determining the respective confidence of each of the at least one initial 3D bounding box according to the respective feature map having subjected to the sparse convolution operation; or
for each of the at least one initial 3D bounding box, executing the sparse convolution operation on the respective merged feature to obtain the respective feature map having subjected to the sparse convolution operation, downsampling the respective feature map having subjected to the sparse convolution operation, and performing at least one of: correcting each of the at least one initial 3D bounding box according to a respective downsampled feature map, or determining the respective confidence of each of the at least one initial 3D bounding box according to the respective downsampled feature map.

17. The apparatus of claim 16, wherein, in downsampling the respective feature map having subjected to the sparse convolution operation, the instructions, when being executed by the processor, cause the processor to carry out the following:
executing a pooling operation on the respective feature map having subjected to the sparse convolution operation for downsampling the respective feature map having subjected to the sparse convolution operation.

18. The apparatus of claim 11, wherein the instructions, when being executed by the processor, cause the processor to carry out the following:
acquiring the 3D point cloud data; and
performing 3D meshing on the 3D point cloud data to obtain 3D meshes, and extracting each of the point cloud semantic features corresponding to the 3D point cloud data from a respective non-null mesh among the 3D meshes.

19. The apparatus of claim 11, wherein, in determining the part location information of the foreground points based on the point cloud semantic features, the instructions, when being executed by the processor, cause the processor to carry out the following:
segmenting, according to the point cloud semantic features, a foreground from a background in the point cloud data to determine the foreground points, wherein the foreground points are point cloud data belonging to the object in the point cloud data; and
processing, by a neural network, the determined foreground points to obtain the part location information of the foreground points, wherein the neural network is configured to predict the part location information of the foreground points,
wherein the neural network is trained by using a training dataset comprising annotation information of a 3D box, and the annotation information of the 3D box at least comprises part location information of foreground points in point cloud data in the training dataset.

20. A non-transitory computer storage medium having stored thereon a computer program that, when being executed by a computer, causes the computer to carry out the following:
acquiring three-dimensional (3D) point cloud data;
determining point cloud semantic features corresponding to the 3D point cloud data according to the 3D point cloud data;
determining part location information of foreground points based on the point cloud semantic features, wherein the foreground points represent point cloud data belonging to an object in the 3D point cloud data, and the part location information of the foreground points indicates a relative location of each of the foreground points in the object;
extracting at least one initial 3D bounding box based on the 3D point cloud data; and
determining a 3D bounding box for the object according to the point cloud semantic features corresponding to the 3D point cloud data, the part location information of the foreground points, and the at least one initial 3D bounding box, wherein the object exists in a region in the 3D bounding box.
